(19) United States
(12) Patent Application Publication
(10) Pub. No.: US 2026/0251444 A1
(43) Pub. Date: Aug. 27, 2026

(54) OPTICAL TESTING DEVICE AND KIT FOR CONSTRUCTION THEREOF

(71) Applicant: SMARTRAY GMBH, Wolfratshausen (DE)

(72) Inventors: Mathias Reiter, Neuried (DE); Alexander Simon, Bad Heilbrunn (DE)

(21) Appl. No.: 18/855,583

(22) PCT Filed: Apr. 5, 2024
(86) PCT No.: PCT/EP2023/058962

§ 371 Date: Oct. 9, 2024

(30) Foreign Application Priority Data
Apr. 11, 2022 (DE) 10 2022 108 725.5

(51) Int. Cl. G01B 11/25; G01D 11/24; G01N 21/88; G01N 21/956

(52) U.S. Cl. CPC G01B 11/2518; G01D 11/245; G01N 21/8806; G01N 21/95684

(57) ABSTRACT

So that the testing device can easily reach the weld seams or solder seams to be inspected, which are often located in recesses or notches, the housing of the testing device is designed similarly to the tool, such as the welding gun, with which the corresponding seam was produced, in other words is designed with a long and slim distance portion between the evaluation portion in which the evaluation electronics are located, and the head portion in which the laser and the optical sensor are located.

### I. FIELD OF APPLICATION

The invention relates to the optical contactless scanning of surfaces in order to determine the three-dimensional contour of the surface.

### II. TECHNICAL BACKGROUND

In industry, the dimensional accuracy of surface contours often has to be checked, for example the cross-section shape of a weld seam or a sealing bead. Optical, contactless scanning methods are often used in this case in order to avoid any risk of damaging the surface.

A common method is the so-called light section triangulation method, in which a light strip is shone on the surface to be scanned, for example transversely over the weld seam, by means of a laser and a light fan produced therefrom, and by means of an optical sensor, such as for example a CCD sensor, the laser light reflected from the surface in different directions, and thus also in the direction of the sensor, is recorded from a scanning direction that is different from the beam direction of the light fan.

From the shape and the path of the light strip image of the light strip on the planar optical sensor, the actual contour of the workpiece surface, for example the weld seam, can be calculated at the location of the incident light strip from a knowledge of the angular offset between the emitted light fan and the viewing direction of the CCD sensor, i.e. the scanning direction.

Due to the relative movement of the light strip transverse to its path, for example along the weld seam, the entire surface of interest can be scanned in this this way multiple times in succession with repeated contour determinations and measured three-dimensionally.

Corresponding optical testing devices are known and comprise, in addition to the light source, usually a laser for generating the light fan, as well as the two-dimensional planar sensor together with the upstream optics, the evaluation electronics for the sensor signals, and also the power supply for all electrical components including voltage conditioning and one or more plug sockets for connecting a plug and transmitting the results to a superordinate control unit. In order to design the testing unit compactly, the housing is usually configured in the shape of a cube.

In addition, the housing of the testing device generally includes a fastening device for fastening it to a surrounding component.

If, for purposes of testing, the surface passes under the testing device in the continuous process method, the testing device is mounted rigidly, whereas in the case of stationary product surfaces the testing device is often fastened to a movable handling unit such as a robot arm and is guided by the latter.

The surface regions that have to be checked most frequently optically include, inter alia, weld seams, soldering seams, adhesive seams or sealing seams, in which connection such surface regions in particular are often not arranged on flat, easily accessible surfaces, but rather in the internal angle between two components, often also in acute-angled internal angles or in locations that are otherwise difficult to reach.

### III. STATEMENT OF THE INVENTION

### a) TECHNICAL OBJECT

The object of the invention is therefore to provide a testing device and in particular a kit for the construction thereof, which can also be used at locations which are difficult to access and in particular can easily be configured according to the spatial conditions of the test task.

### b) SOLUTION OF THE OBJECT

This object is achieved by the features of claims 1 and 16. Advantageous embodiments are disclosed in the dependent claims.

Since such seams have to be produced beforehand under the same conditions of accessibility, the corresponding processing units, for example welding devices or soldering devices or metering devices for dispensing adhesive or sealant, are often in the shape of a pistol and are referred to as welding guns, etc. This means that a relatively long, in particular thinner distance portion of the housing of the device, at the front end of which is fastened the actual working head, in other words a welding head or a metering head, extends forwardly from the handle (in the case of a manually guided welding gun) or from a rear fastening flange (in the case of a welding gun guided by a robot arm). Due to this distance portion, machining points located in deep and narrow cavities can also be reached.

The basic concept of the invention is to accommodate the optical testing device not, as previously, in a generally cuboid, often approximately cube-shaped housing, but instead in a housing that has approximately the same shape as the processing unit that has generated the seam or bead to be checked, for example the shape of a conventional welding gun, soldering gun or dosing gun as described hereinbefore.

With regard to the testing device, the present object is accordingly achieved in that the housing of the testing device comprises a plurality of housing portions that together form a housing that is formed relatively thin transverse to the largest extension direction of the testing device, the longitudinal direction or axial direction of the testing device, at least in the front region, and thus has an elongated slim housing at least in the front region, in order also to be able to optically check surface regions which were generated by a similarly shaped gun-like implement, wherein at least the test head of the testing device can be brought sufficiently close to the surface area of interest, such as a weld or a sealing bead.

Therefore, according to the invention such a housing comprises three portions, namely
a head housing at the front free end of the housing, in which on the one hand the light source, and on the other hand the optical sensor—which together are referred to as test head—are located, but in particular not the processing unit, which requires a relatively large amount of space,
an evaluation housing located at the opposite rear end of the housing from this front end and in which specifically this electronic processing unit is located, which together with voltage conditioning and signal onward transmission consists of a plurality of electronic circuit boards, which are equipped with electronic components such as resistors and diodes, etc. and are electrically connected to one another and form one or more electronic circuits, and
between these two housing portions there is located an elongated distance housing, preferably hollow like a tube, through which or along which the electrical lines can run from the head housing to the evaluation housing.

An elongated distance housing is understood to mean, in particular, one in which in the direction of its greatest extension, the axial distance direction, it is at least 5 times, better 7 times, better 10 times as long as its largest transverse extension measured perpendicular thereto.

In particular, the distance housing has a greatest transverse extension of at most 5 cm, better at most 4 cm, better at most 3 cm, better at most 2 cm.

In particular, the distance housing has an axial distance direction of at least 15 cm, better at least 20 cm, better at least 30 cm, better at least 40 cm.

Such an elongated distance housing serves merely so that head housings that are clearly smaller in the transverse direction measured relative to the longitudinal direction, at least by a factor of 3, better by a factor of 4 compared to the evaluation housing, can be placed sufficiently far away from the evaluation housing that is of greater thickness, that is to say greater transverse extension, so that the head housing—which is designed to be as small as possible in particular as regards its transverse extension—can also be inserted into relatively narrow gaps and recesses.

Preferably, these three housing portions are also designed as separate housing parts which can be connected to one another in a tight but detachable manner, in particular can be screwed together. This simplifies and reduces the production costs of the individual housing parts, but also enables a construction kit with differently designed housing parts to be realized, in order to produce a longer or shorter testing device depending on the particular application, by means of, for example, variously long distance housings.

The axial directions of the individual housing portions or housing parts do not have to be aligned with one another.

Thus, the axial head direction of the head housing can extend from its rear end to its front end at an angle to the axial distance direction of the generally straight and rod-shaped distance housing, and also the axial evaluation direction of the evaluation housing does not have to adjoin flush to the axial distance direction of the distance housing at the rear. The respective axial direction is understood to mean that direction in which the respective housing portion has its greatest extension.

Moreover, the distance housing can instead also be curved or arcuate depending on the work task and accessibility of the surface regions to be checked.

The length of the distance housing in the axial distance direction should preferably be at least twice, better at least three times, better at least five times the length of the head housing in its axial head direction.

In order not to impede the insertion of the head housing into narrow recesses, the greatest thickness of the distance housing, i.e. measured perpendicular to its axial direction, should preferably be less than the greatest thickness of the head housing, in particular less than 0.7 times the greatest thickness of the head housing. The thickness is understood to mean the greatest transverse extent of a housing portion perpendicular to its axial direction.

The testing device according to the invention may include further components:

For example, it may include a flange ring protruding laterally over the evaluation housing, or a flange plate that serves for fastening, in particular screwing, to a handling unit such as the front end of a robot arm. Preferably, such a flange ring or a flange plate is located at the rear end of the testing device and especially at the rear end of its evaluation housing, and at the same time can as a flange plate form the rear end wall of the evaluation housing.

The testing device can furthermore comprise a plug socket in a wall of the evaluation housing for inserting a plug for the wired electrical connection, in particular a signal connection, with a superordinate test unit, for example a control center for controlling the testing device.

Such a testing device can further comprise an adapter plate, in particular an annular adapter plate, in order to be able to secure the flange ring or the flange plate on variously designed receptacles, for example differently designed robot arms, since each robot arm generally has, for example, a different hole pattern for screwing on a tool, and the flange ring or the flange plate cannot contain all the hole shapes available on the market.

This is possible by means of an adapter plate, which has through openings or threaded openings matching on the one hand the hole shape of the flange plate and on the other hand the hole shape of the robot arm for example.

The testing device can also comprise a strain relief device for fixing the cable inserted into this plug socket with an end plug, which prevents pulling on the cable, in particular in the direction for removing the plug from the plug socket, but also in the transverse direction to the running direction of the cable.

Such a strain relief device generally comprises a holding rod running in the longitudinal direction, which can be fastened with its front end to the evaluation housing, in particular its flange plate, and at the rear end has the fastening device, for example a clamping device, in which the cable leading to the plug socket is fixed for relieving the strain.

In the case of the robot arms on which such testing devices are fastened, it is in principle possible to distinguish between hollow arm robots, which comprise hollow arm parts continuous in their longitudinal direction, and non-hollow arm robots:

Whereas in the case of hollow arm robots the cable is generally guided in the interior of the hollow arm parts of the robot, in the case of non-hollow arm robots the cables must be guided along the outside of the robot arm and fixed in situ there.

Accordingly, the plug socket is then generally only fastened centrally to the rear end wall of the evaluation housing, in particular its flange plate, when the testing device is to be fastened to such a hollow arm. The strain relief then usually takes place in the same way as the cable held therein in the interior of the adjoining hollow arm part of the robot.

In the case of a non-hollow robot arm, the plug socket—or in this case often two or more separate plug sockets—is located in a circumferential wall of the evaluation housing, where one or more cables are then inserted and the adjoining cables are guided along the flange plate on the outside of the robot arm.

In order that the electrical signals to be guided in the signal lines from the head housing to the evaluation housing are not adversely affected by electromagnetic radiation on this relatively long path, the signal lines are not only formed overall as an electromagnetically shielded coaxial cable—that is to say with a circumferentially encasing shielding around the signal line—but each individual wire of the multi-core signal line is so formed, so that the mutual electromagnetic influence is also avoided.

This measure in particular enables testing devices extending over a very long distance with a long distance housing to be implemented.

Depending on the spatial situation of the surface regions to be checked, it may be expedient if the head housing, aligned with its axial head direction at an angle to the axial distance direction of the distance housing, can be fastened, in particular screwed, in different rotational positions on the distance housing, especially when the distance housing is not a straight, but is a bent or angled distance housing.

The fastening elements, in particular the screwing elements such as screw holes, are therefore preferably formed on the distance housing on the one hand and on the head housing on the other hand in such a way that they can be fixed with respect to one another in multiple different rotational positions, in particular around the axial distance direction.

A similar configuration between the distance housing and the evaluation housing may also be expedient, especially if the evaluation housing is not formed symmetrically about its axial direction and/or the distance housing is not fastened centrally on the evaluation housing.

In order for the head housing to be able to reach into the depth of narrow cavities sufficiently close to a weld seam for example, then from the side view of the testing device, which is angled in particular in the region of the head housing, the head housing is designed to become narrower from its thickest point towards the free end.

Preferably the head housing has, seen from the side, an upper and a lower head end region at its free end, which are separated from one another there by an incision extending from the free end into the head housing. One of the two head end regions is preferably located more forwardly than the other in the axial head direction, and in the case of a downwardly angled head housing the upper head end region preferably projects further.

This enables the light source, in particular the laser, to be arranged in the more forwardly projecting head end region, and the two-dimensional sensor with its sensor surface, in particular including the upstream optics of one or more optical lenses, to be arranged in the recessed head end region. As a result, a very small thickness of the head housing may be sufficient.

In this connection the light, in particular the light fan, is preferably emitted from the head housing in an emission direction which is at an acute angle relative to the axial head direction—which in particular coincides with the “viewing direction” of the sensor aligned perpendicular to the sensor surface—which is likewise arranged in the narrowing end region of the head housing.

The optical system mounted upstream of the planar sensor, which can consist of one or more optical lenses, is preferably prefabricated as a unit and is inserted from the free end side into the end region of the head housing from the front or is screwed in. In this mounted position the optics can additionally be protected and/or held by means of a protective cap that can be fixed to the head housing, which naturally must have a through-opening in its front side for the incoming light.

The emission direction of the light from the light source, which is likewise arranged in the narrowing end region of the head housing, extends outwardly at an obtuse angle to the emission direction of the light from the head housing, which is achieved by means of deflection by a mirror arranged in the head housing.

By means of both these measures overall the head housing seen in side view, i.e. in the viewing direction of the intermediate angle between the axial distance direction and the axial head direction, can be chosen to be narrower than with an arrangement of the light source, so that its light fan is emitted from the head housing without being deflected by a mirror.

Furthermore, a functional display of the testing device visible from the outside is preferably provided directly in the wall of the head housing, which is illuminated by a LED located within the head housing, so that it can be seen directly on the head housing at any time whether or not the testing device is in operation. For this purpose a translucent wall portion is preferably contained in the wall of the head housing, for example a light guide made of glass or plastic, which is installed tightly in the wall, The electronic processing unit in the interior of the evaluation housing is also of modular construction, in which the electronic circuits to be accommodated there, which of course serve different purposes, are distributed over a plurality of circuit boards that are detachably connected to one another.

On the one hand this includes the evaluation circuit board on which at least the evaluation circuit for the signals of the sensor is arranged, preferably also additional electrical or electronic components for voltage conditioning in order to meet the needs of the sensor and the light source.

Since this evaluation circuit board is generally a bought part, which is supplied for example together with the two-dimensional sensor and matches the latter, the evaluation circuit board does not have the necessary connections however, and is not in the form required for example for the plug socket and/or the laser.

An interface circuit board is therefore included, which offers this facility and is electrically connected to the evaluation circuit board, preferably is plugged onto the latter via electrical plug contacts on both sides. The entire data traffic and current traffic from and to the evaluation circuit board thus take place via the interface circuit board.

Both can be fixed, normally screwed, together to the inside of an outer wall, preferably the circumferential wall, of the evaluation housing.

In order to provide the electrical inputs and outputs corresponding to the requirements of the evaluation circuit board and/or the interface circuit board, the plug socket is not connected directly to the interface circuit board, but is connected via an I/O (input/output) circuit board that has the required electrical connections to the other circuit boards, but however has the socket-specific connections for the plug socket.

Accordingly, the I/O circuit board is arranged close to the plug socket, in particular on the inside of the wall in which the plug socket is inserted, i.e. it penetrates this.

Thus, a corresponding I/O circuit board that matches the installed plug sockets can always be used, without having to adapt the interface circuit board to the respective plug socket that is used.

In this way adaptations of the electronic evaluation circuit to the surroundings, whether it is the plug sockets used, the lasers used and the like, can be implemented very easily, since only parts of the circuitry in the form of the corresponding circuit board have to be modified and replaced for this purpose.

As a result of the afore-described design and construction a kit can be provided, which enables a large number of differently designed variants of the testing device to be created by means of relatively few different individual parts.

Thus, on the one hand, with regard to the housing the kit can comprise at least one type of evaluation housing and at least one type of head housing, but several types of distance housings, wherein these types of distance housings differ for example in their length in their axial direction. In this way housings for such testing devices, extending to different lengths, can be created in a simple manner, in that the selected three housing parts are detachably connected to one another, for example are screwed together.

In this connection the different types of distance housings can preferably comprise both a straight type and an angled or bent type, depending on the spatial circumstances of the existing work task.

As further kit parts, one or preferably a plurality of different flange plates can be provided for fastening to the rear end of the housing, in particular the evaluation housing or even as part of the evaluation housing, so that a matching flange plate can be selected depending the component to which the testing device is to be fastened.

If such a matching flange plate is not available, a corresponding adapter plate can be installed between the flange plate and the component carrying the testing device, which has fastening devices that on one side match the flange plate and on the other side match the supporting component, for example a corresponding screw hole pattern.

Depending on the different lengths of the distance housings, the kit should also comprise types of electrical signal lines and/or current lines that differ at least as regards their length, which are to run preferably in the distance housing and electrically connect the test head on the one hand and the evaluation unit on the other hand.

In this case the signal lines are preferably implemented as shielded coaxial cables, and specifically in particular for each individual wire of the signal lines, wherein a wire is not understood to mean the individual wire of a strand, but rather the entire wire, which also conducts the same signal.

Furthermore, preferably not only one but several types of plug sockets are provided, which can be mounted in the wall of the evaluation housing for signal onward transmission.

Accordingly, not only one type of evaluation housings but several types are provided, depending on, for example, in which wall of the evaluation housing the passage for the corresponding plug socket is located.

The kit preferably also comprises a strain relief device as a kit part, which can be fastened to the evaluation housing or the flange plate or the adapter plate.

Also, with regard to the construction of the specific electronic evaluation unit in the interior of the evaluation housing the kit can comprise different kit parts, in particular in addition to the various types of housing parts:

On the one hand an evaluation circuit board can be provided as a kit part, which carries at least the evaluation circuit for the signals supplied by the sensor.

Furthermore, an interface circuit board can be provided as a kit part, which can be coupled to the electrical inputs/outputs of the evaluation circuit board, in particular directly via plug connectors, so that the entire input and output with regard to signals and power supply to the evaluation circuit board takes place via the interface circuit board.

Furthermore, the kit can comprise as a kit part an I/O circuit board, which has on the one hand inputs and outputs matching those of the plug socket, and on the other hand matching the inputs and outputs of the interface circuit board, in other words matching not only as regards the physical shape of the connecting elements, but also the electrical parameters, such as voltage, current intensity, etc.

The circuit boards described above are of course not empty electronic circuit boards, but are already fully equipped with the corresponding semiconductors. i.e. electronic components, and include electronic circuit boards wired to an electronic circuit.

### c) EXEMPLARY EMBODIMENTS

Embodiments according to the invention are described in more detail hereinbelow by way of example. In the figures:

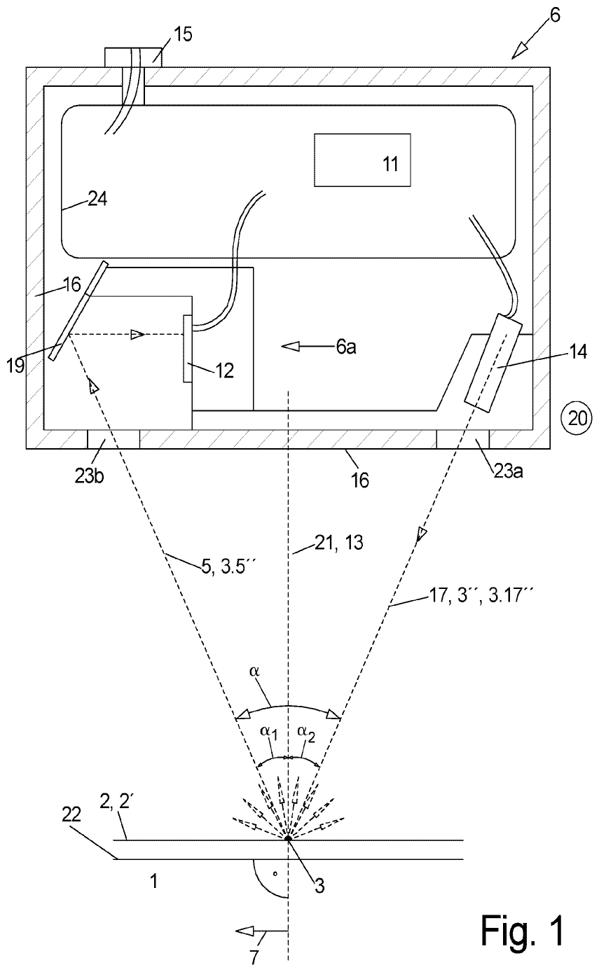

FIG. 1: shows a side view of a testing device according to the prior art for applying the light section triangulation method,

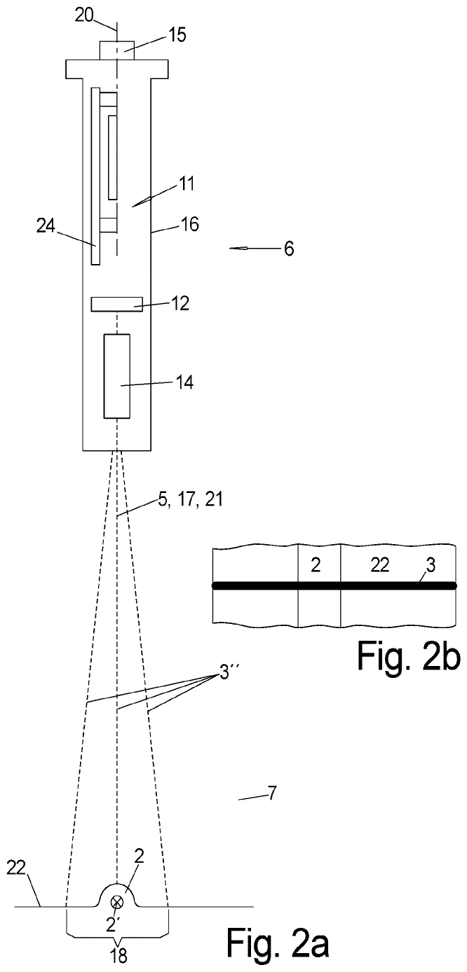

FIG. 2a: shows the testing device of FIG. 1 in a front view,

FIG. 2b: shows a plan view of the surface of the object,

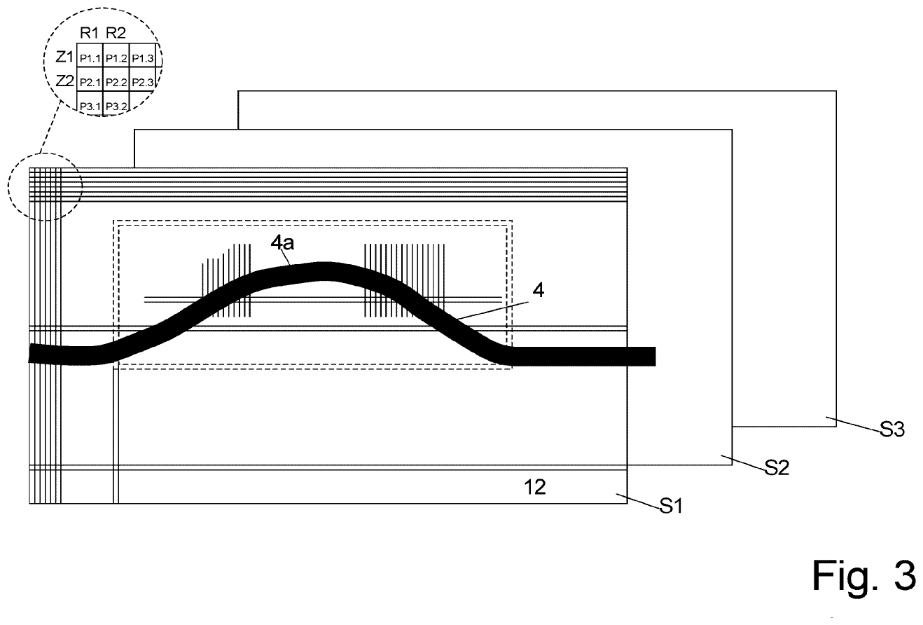

FIG. 3: shows a light strip image on the planar sensor,

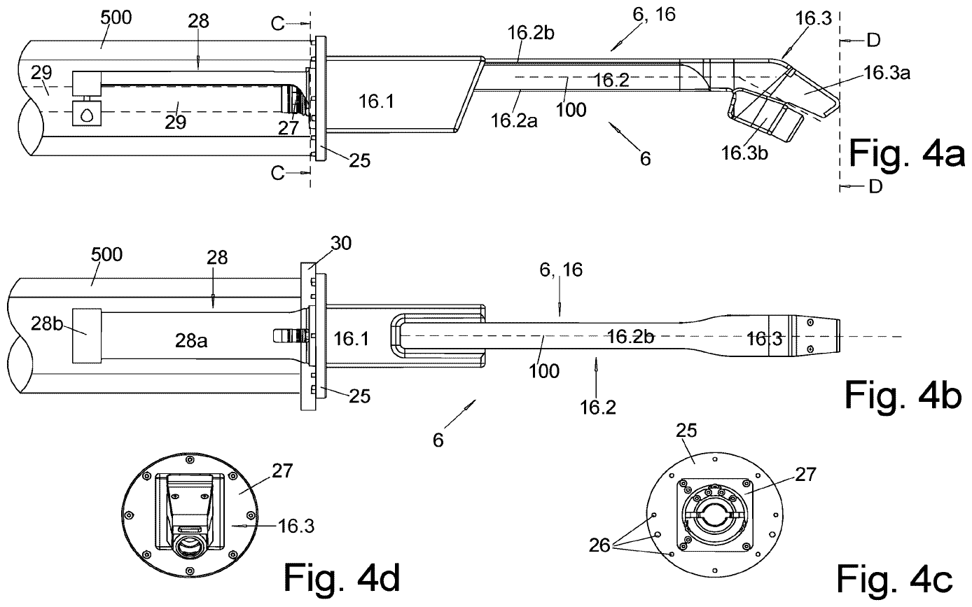

FIG. 4a, b: shows a testing device according to the invention in side view and in plan view,

FIG. 4c: shows a front view of the testing device according to FIG. 4a, b corresponding to the line C-C in FIG. 4a,

FIG. 4d: shows a front view of the testing device according to FIG. 4a, b corresponding to the line D-D in FIG. 4a,

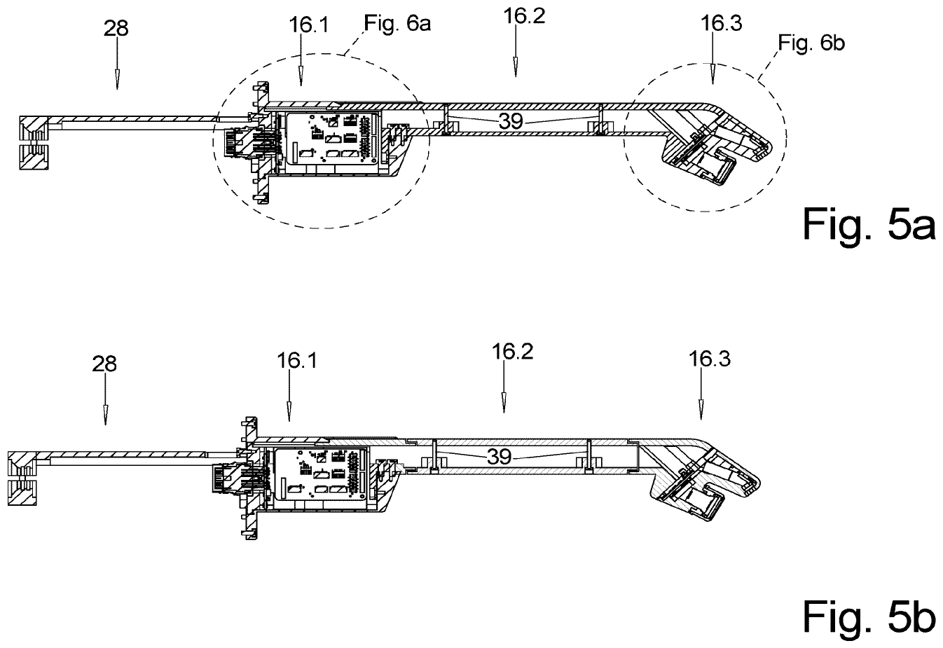

FIG. 5a, b: shows longitudinal sections through the testing device according to FIG. 4a, b in the same viewing direction as in FIG. 4a,

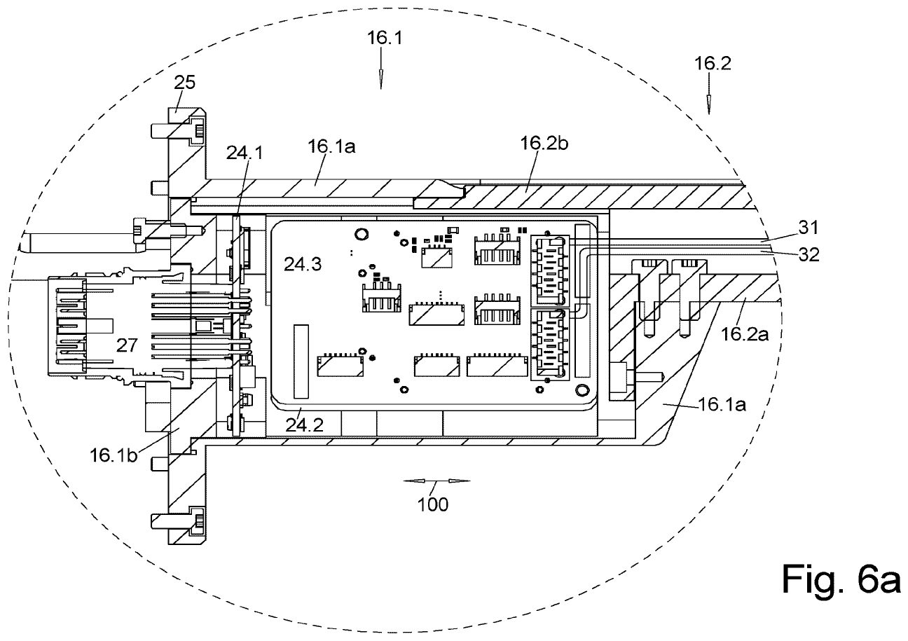

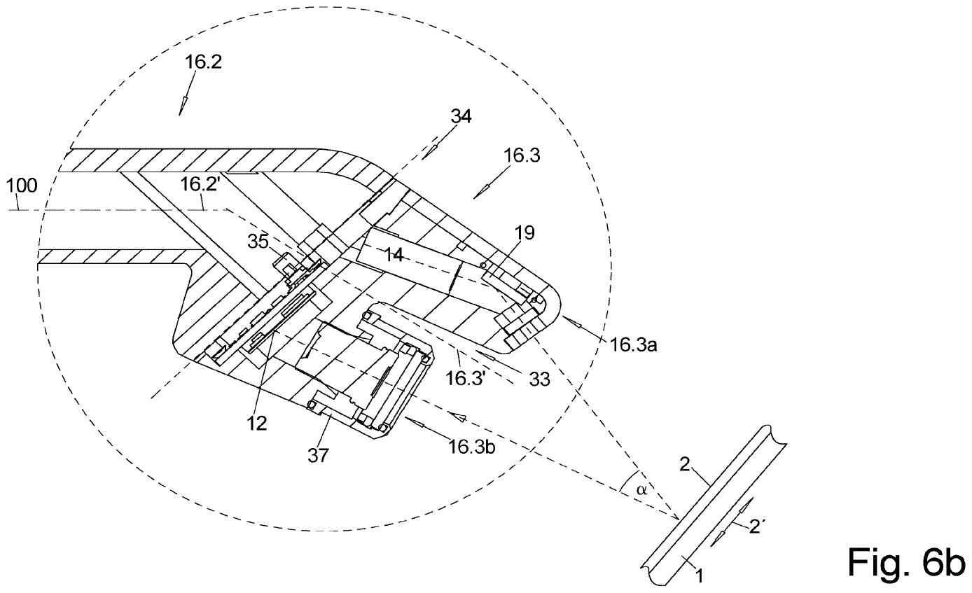

FIG. 6a, b: shows a detailed enlargement of FIG. 5a, b.

FIG. 1 shows a side view of a known, cuboid-shaped testing device 6, from which it can also be seen how the known light section triangulation method works in principle, which is to be used within the scope of the invention preferably before other optical, contactless test methods, which are based on the reflection of light at the surface to be checked:

In this case a light fan 3″, generally produced by a laser as light source 14, is directed onto the surface 22 of an object 1 and generates a light strip 3 there, which on account of the fan shape—as can be seen in FIG. 2b—is in the shape of a strip with a light strip length 18, as can be seen in FIG. 2a.

The light fan 3.5″ reflected by the surface 22 of the object 1 generates a light strip image 4 in the testing device 6 on the planar optical sensor 12 of the detector unit 6a, and in an electronic processing unit 11 for processing the image data recorded by the sensor 12 calculates the result data that reproduce the surface contour of the surface 22 along the light strip 3.

Although the light fan 3″ has a thickness—although a very small thickness—and likewise the light strip 3 has a width, then due to these very small dimensions the light fan 3″ is, for the purposes of the present application, equated with the geometric light fan plane 3 in which it lies, for example in that the light fan plane 3″ is said to lie in the middle of the thickness of the light fan 3″.

The beamed light strip 3 is also primarily characterized by its extension direction 3′.

In order that a light strip image 4 is recorded on the optical sensor 12, thus enabling conclusions to be drawn about the actual contour of the surface 2, the scanning direction 17 of the light fan 3″—viewed in the direction of the path direction 3′ of the light strip 3—and the scanning direction 5 of the detector unit 6a do not coincide, but must differ by a triangulation angle α.

In the present case the testing device 6 is arranged in such a way that the angle bisector 13 between the beam direction 17 of the light fan 3″ and the scanning direction 5 of the detector unit forms a perpendicular 21 to the surface 22, i.e. these two directions therefore each assume an intermediate angle α₁=α₂ to the angle bisector 13, which in total form the triangulation angle α.

An unevenness, for example an elevation 2a as shown in FIG. 2a, in the impact region on which the light fan 3″ shines will as a light strip 3 on the surface 22 and thus as a light strip image 4 on the sensor 12 produce not a straight light strip 4 but a light strip 4 with a bulge 4a, as shown in FIG. 3b, wherein this bulge 4a of the light strip image 4 depends on the triangulation angle α and the position of the angle bisector 13 with respect to the surface 22 of the object 1, and differs from the actual shape of the bulge 2a, sectioned along the perpendicular axis 21.

According to FIG. 1, in the case of a structure of the surface 22 that diffusely scatters incident light, the light incident in the region of the light strip 3 with its path direction 3′ is scattered diffusely in all directions, and a part thereof is reflected in the direction of the detector unit 6a, i.e. in the direction of the passage 23b in the housing 16 of the testing device 6.

The stronger the surface 22 reflects, the less the incident light is diffusely scattered, but is reflected only in a specific direction. Only if this reflection direction corresponds to the scanning direction 5 of the detector unit 6a is a light strip image 4 formed on the sensor 12.

Because of the known position of the testing device 6 as well as its triangulation angle α and also the focusing of the testing device 6 on the surface, the actual dimensions of the bulge 2a on the surface 22 can be calculated from the dimensions of the light strip image 4.

As FIG. 1 shows, the testing device 6 is constructed in a very compact manner from the dimensions in its main plane 20, wherein the light source 14, generally a laser cartridge, is arranged close to the passage 23a provided for the light beam in the housing 16, and the optical sensor 12 is arranged close to the other passage 23b, both of which are located in one of the slim sides of the housing 16, wherein a deflection of the light fan 3.5″ arriving in the scanning direction 5 frequently occurs between this passage 23b and the optical sensor 12 via a mirror 19 in a direction approximately parallel to the outer edge, in which the passages 23a, b are located.

Both the sensor 12 and the mirror 19, which together form the detector unit 6a, are in this connection fastened to a detector base body, which in turn is fixed in the housing 16.

As a result, a sufficient amount of space remains on the half of the housing 16 facing away from the outside with the passages 23a, b, in order to arrange there a circuit board 24 lying parallel to the main plane 20 of the housing 16, which contains the entire electronic processing unit 11 and is connected to the sensor 12 via electrical lines, like the light source 14. The result data determined by the processing unit 11 are output via a plug or cable outlet 15.

The individual recordings produced by the light section triangulation method, the scans S1, S2, S3, etc. are repeated in a temporally rapid sequence, so as to constantly observe the surface 22 of the object 1 moving relative to the testing device 6 in the movement direction 7.

FIG. 3 shows a typical strip-shaped light strip image 4 of the light strip 3, including a bulge 4a, as is formed on account of an elevation 2 on the surface 22 on an optical sensor 12, if the extension direction 3′ of the light strip 3 lies transverse to the path direction 2′ of the elevation 2:

Since the area of the optical sensor 12 is divided in a raster-like manner into individual pixels, for example P30.17, by lines Z1, Z2, etc. as well as by rows R1, R2, the evaluation of the optical sensor 12 shows which of these pixels are impacted by the light strip image 4 and have a higher brightness value than the non-impacted pixels.

The entire three-dimensional contour of the regions of the surface 22 to be tested can be determined with the aid of the successively executed recordings, the scans S1, S2, etc.

FIGS. 4a-6b show a structural embodiment of the testing device according to the invention.

In this case the housing 16 of the testing device extends forward from a flange plate 25, in the case of FIGS. 4a, b and 5a, b to the right in its general longitudinal direction 100, and has three differently designed housing portions:

Adjacent to the flange plate 25 is a first housing portion, the so-called evaluation housing 16.1—wherein the flange plate 25 together with the circumferential wall of the evaluation housing 16.1 can be formed in one piece—which seen in a side view can be thicker than the adjoining 16.2 distance housing extending in the same longitudinal direction 100, with its axial distance direction 16.2′, and at the front end of which is located the head housing 16.3, which in turn is thicker than the distance housing 16.2, and on the other hand, in its axial head direction 16.3′, also runs at an angle to the latter seen in a side view. As explained later, the evaluation circuit for the sensor signals is essentially located in the evaluation housing 16.1, while the light source, i.e. the laser 14, as well as the optical sensor 12 are located in the head housing 16.2.

At least one signal line 31 and at least one current line 32 run in the interior of the hollow tubular distance housing 16.2 from the electronics in the evaluation housing 16.1 to the laser 14 and sensor 12 in the head housing 16.3.

The basic idea is that, most importantly, the head housing 16.3 should be dimensioned as small as possible, in particular in its thickness transverse to its axial head direction 16.3′, in order to be able to optically scan the surface even in the case of poorly accessible surfaces, for example in narrow gaps and other depressions.

The flange plate 25 serves for fastening to a component carrying the testing device 6, here for example the front end of a robot arm 500, which in this case is hollow, so that a cable 29 can reach through the interior of the robot arm 500 to the plug socket 27, which is inserted approximately centrally in the flange plate 25 in order to connect the testing device 6 to a superordinate control (not shown).

Therefore, in this case a strain relief device 28 projects to the rear from the flange plate, i.e. into the robot arm 500, which strain relief device 28 consists of a support rod 28a, which likewise extends approximately in the main extension direction 100 of the testing device 6a piece a bit further into the robot arm, and has at its free end a fastening device, usually a clamping device 28b, in which the cable 29 leading to the plug socket 27 is clamped in order to achieve the desired strain relief.

The plug socket 27 can comprise a different number of pins and is shown in FIG. 4c.

In the plan view of FIG. 4b, an adapter plate 30 is furthermore provided between the robot arm 500 and the flange plate 25, which serves to adapt the fastening elements on one side to the fastening elements of the robot arm 500 and the other side matches the fastening elements of the flange plate 25, wherein the fastening elements can for example be through holes or thread bores.

In the case of the construction of FIGS. 4a-4d—which is shown in longitudinal section in FIG. 5a—the distance housing 16.2 consists of two parts with respect to the circumference, namely a lower trough approximately U-shaped or C-shaped in cross-section, which is screwed at one end onto the evaluation housing 16.1 and at the other end to the head housing 16.3. This trough is open on the upper side and can be closed by an upper cover, wherein the cover can preferably be inserted with one end under a corresponding wall part of the evaluation housing 16.1, and is drawn in close by holding screws screwed in from the underneath, i.e. the trough-shaped base part, and tightly closes the opening. The lines 31, 32 running in the distance housing 16.2—which are not shown in FIG. 5a—can be guided past on these holding screws 38.

For the present application top and bottom means that bottom denotes the side in which direction the head housing 16.3 is angled.

In the construction of FIG. 5a the contact surface at the front free end of the distance housing 16.2, which is already bent at the front end, thus runs obliquely to the axial direction 100, the main extension direction of the testing device 6, i.e. the direction in which the housing 16 has its greatest extension and which in this case is at the same time the extension direction of the distance housing 16.2 in its central region.

As can be seen, the distance housing 16.2 also is not attached centrally to the front end face of the evaluation housing 16.1, but in its upper region.

For this reason, and also because the movement capability of a robot arm can be of different magnitude depending on the direction of movement, it may be expedient, depending on the work task, to choose the length of the central distance housing 16.2 larger or smaller, select the intermediate angle between the axial distance direction 16.2′ of the distance housing 16.2 and the axial head direction 16.3′ of the head housing 16.3 differently, and in particular select differently the radial direction with respect to which the head housing 16.3 is bent.

In order to enable this, FIG. 5b also shows a second design in longitudinal section, in which evaluation housings 16.1, distance housings 16.2 and head housings are separate housing parts, which lie perpendicular to the axial direction 100 of the straight distance housing 16.2, and can be placed adjacent to and fastened to one another In this way housings 16 can be created in a very simple manner from the basic structure, the so-called pistols shape, that are similar to the latter but are differently designed in terms of their specific dimensions.

As can best be seen in the enlargement of FIG. 6a, the evaluation housing 16.1 also consists of multiple parts: an approximately pot-shaped base part 16. FIG. 1a is open at its rear, in this case left, end face and can be closed by a front cover 16.1b inserted there, in that the plug socket 27 had previously been arranged in a corresponding passage and an I/O circuit board 24 was mounted on pins pointing in the direction of the interior of the evaluation housing 16.1 and was soldered to the latter, said board having a hole pattern corresponding to these pins, and after installing the end cover 16.1b transversely to the axial direction 100 in the evaluation housing 16.1, sits close to its front cover 16.1b.

The insertion of the front covers 16.1b equipped in this way usually takes place after the I/O circuit board 24.1 is wired up to the remaining further circuit boards, already previously installed in the evaluation housing 16.1.

This is primarily the evaluation circuit board 24.2, which extends in the axial direction, being the longitudinal direction, of the evaluation housing 16.1 and substantially takes up its entire free space.

An interface circuit board 24.3 is provided in parallel to this and is preferably connected to the evaluation circuit board 24.2 via plug contacts soldered on both sides, said interface circuit board 24.3 comprising connecting elements adapted to its plug contacts or soldering points on the side pointing towards the evaluation circuit board 24.2, but however is always of the same design on the supply side and discharge side for signals and current, and for example is adapted to the signal line 31 and the power line 32 as well as the plug attached thereto.

As a rule the interface board 24.3—over which the entire data traffic as well as the power supply from and to the evaluation circuit board 24.2 run—is similar in size to the evaluation circuit board 24.2.

The evaluation housing 16.1 also has in the bottom of its cup-shaped base part 16.1a an outlet opening for lines 31, 32 which is closed by the distance housing 16.2 attached to this front end of the evaluation housing 16.1. 2, wherein its base part 16.2a is screwed to the base part 16.1a, while the upper cover 16.2b of the distance housing 16. 2 is screwed to the base part 16.2a thereof.

In the enlargement of FIG. 6b the head housing 16.3 can be recognized more easily, and also the front end of the distance housing 16.2.

It is clear here that in this construction the contact plane between these two housing parts is at an angle different from 90°, approximately at a 45° angle, with respect to the axial distance direction 16.2′ of the distance housing 16.2.

FIG. 6a also shows that the head housing 16.3 consists not only of a wall of approximately constant wall thickness, but is a rather massive part provided with openings for receiving the parts of the test head to be installed, namely
the laser 14 on the one hand, and
the two-dimensionally planar optical sensor 12 with upstream optics on the other hand.

The head housing 16.3 shows furthermore according to FIG. 6b—in a side view, in which the different directions of extension of the distance housing 16.2 on the one hand and the head housing 16.3 on the other hand can be recognized—that the head housing 16.3 consists of an upper and a lower head end region 16.3a, 16.3b, between which there is an incision 33 open towards the free end of the head housing 16.3.

In this case the head end region 16.3a, in which the laser 14 is located and which is usually the upper head end region, projects further forwards than the other, generally the lower, head end region 16.3a

The planar sensor 12 and the upstream optical unit are arranged in the lower head end region 16.3b, wherein the central axis of the optical system is not perpendicular to the surface of the sensor 12, but this can be taken into account however by computation in the evaluation.

Furthermore, the light fan emitted by the laser 14 does not exit directly through a translucent window in the upper head end region 16.3a, but this light fan is previously diverted by a mirror 19 so as to leave in an exit direction that differs from the central axis of the optical system of the camera by a triangulation angle α.

The optical system is inserted from the outside into an opening of the head housing 16.3, which extends up to the sensor 12—inserted and mounted from the rear side of the head housing 16.3—and the optical system can be secured in this plugged-in position by an attached or screwed-on protective cap 37—with a sufficiently large opening in its front surface for light to enter. The attachment or screwing-on of the protective cap 37 is possible only because of the incision 33.

The deflection via the mirror has the effect that the laser 14 does not have to be arranged in the extension direction of the light fans incident on the object 1, and as a result the head housing 16.3 in this side view can be designed very narrow and tapering towards the front free end.

### LIST OF REFERENCE NUMERALS

1 Object
2 Surface, elevation, bead
2 Path direction
3 Light strip
3 Extension direction, path direction of light strip
3″ Light fan, fan Plane
3.17″ Emitted light fan
3.5″ Reflected light fan
4 Light strip image
4a Bulge
4b Depression
5 Scanning direction, observation direction, reflected light beam, reflection direction
6 Testing device
6a Detector unit
7 Direction of movement
8 Rod lens
8 Path direction
8′ Optical axis
9 Spacing
10 Diffuser
10″ Diffuser plane
11 Electronic processing unit
12 Optical sensor
13 Angle bisector
14 Light source
15 Plug, cable outlet
16 Housing
16.1 Evaluation housing
16.2 Distance housing
16.3 Head housing
16.3a, b Head end region
17 Beam direction
18 Observation width, light strip length
19 Mirror
20 Main plane
21 Perpendicular
22 Surface
23a, b Passage
24 Circuit board
24.1 I/O circuit board
24.2 Evaluation circuit board
24.3 Interface circuit board
25 Flange plate
26 Screw opening
27 Plug socket
28 Strain relief device
29 Cable
30 Adapter plate
31 Signal line
32 Power line
33 Incision
34 Function display
35 LED
36 Light guide
37 Protective cap
38 Retaining screw
100 Axial direction
500 Robot arm
Z1 Line
R1 Row
S1, S2 Scan
α Triangulation angle
α1, α2 Intermediate angle
β Deflection angle

1. Testing device for the optical, contactless scanning of a surface of an object, the testing device comprising:
a light source that beams a light fan in a beam direction onto the surface and generates a light strip there;
a planar, optical sensor whose scanning direction directed onto the light strip is in a triangulation angle (α) with respect to the beam direction of the light fan when viewed in the path direction of the light strip;
an electronic processing unit for processing the signals supplied by the sensor; and
a housing in which the aforementioned components are located, wherein the housing comprises:
an evaluation housing in which the processing unit is located;
a head housing in which the light source and the optical sensor are located; and
an elongated distance housing through which run the electrical lines between the head housing and the evaluation housing.

2. Testing device according to claim 1, wherein:
the evaluation housing, the head housing, and the elongated distance housing are connected to one another in a tight but detachable manner.

3. Testing device according to claim 1, wherein:
the axial head direction of the head housing at its front end, viewed from the side, runs in a bend angle to the axial direction of the distance housing at a bend angle of 10° to 40°.

4. Testing device according to claim 1one wherein:
the length of the distance housing along its greatest extension, the axial distance direction, is at least twice the length of the head housing;
and/or
the greatest thickness of the distance housing in a transverse direction perpendicular to the axial distance direction is less than the greatest thickness of the head housing transverse thereto, in particular is less than 0.7 times this thickness.

5. Testing device according to claim 1 wherein the testing device comprises:
a flange plate protruding laterally over the evaluation housing, with screw openings for screwing for example to the front end of a robot arm at the rear end of the evaluation housing, which forms the rear end wall of the evaluation housing;
and/or
at least one plug socket in a wall of the evaluation housing for electrically connecting the testing device to a superordinate unit;
and/or
a strain relief device projecting rearwards from the evaluation housing, in particular from the flange plate, for a cable leading up to the testing device;
and/or
an adapter plate for screwing on the one hand to a supporting component part and on the other hand to the flange plate or the flange ring of the housing of the testing device.

6. Testing device according to claim 1, wherein:
the strain relief device comprises a supporting rod extending in the longitudinal direction, as well as at its rear end a fastening device for an electrical cable.

7. Testing device according to claim 1, wherein:
either only one plug socket is arranged in the rear end wall of the evaluation housing
or multiple plug sockets are arranged in the circumferential wall of the evaluation housing, in particular located behind one another or spaced apart from one another in the axial direction.

8. Testing device according to claim 1, wherein the electrical signal lines are formed as electronically shielded coaxial cables, in which each individual wire of the line is shielded separately as coaxial cable.

9. Testing device according to claim 1, wherein the fastening elements on which at least one end of the distance housing on the one hand and also the evaluation housing and/or the head housing on the other hand are designed such that the distance housing can be fastened in different rotational positions about the longitudinal direction of the testing device in the region of the contact surface with the adjoining other housing part opposite thereto.

10. Testing device according to claim 1, wherein:
viewed from the side, from its thickest point the head housing becomes narrower towards the front and has an upper and a lower front head end region separated from one another by an incision; and
one of the two head end regions protrudes further in the axial head end region than the other head end region.

11. Testing device according to claim 1, wherein the light source is arranged in the more forwardly projecting head end region, and the sensor is arranged in the set-back head end region.

12. Testing device according to claim 1, wherein:
the beam direction of the light from the head housing is at an acute angle with respect to the axial direction of the optical system of the sensor in the narrowing end region of the head housing; and
the beam direction of the light from the light source arranged in the narrowing end region is at an obtuse angle to the beam direction of the light from the head housing by means of deflection by a mirror.

13. Testing device according to claim 1, wherein:
the wall of the head housing, in particular its upper side, contains a function display for the testing device that is illuminated by an LED and is visible from the outside and
is in the form of a light-permeable wall portion, in particular a light guide, let into the wall.

14. Testing device according to claim 1, wherein:
the objective lens is inserted from the free end side into the end region of the head housing,
in this case the objective lens is held and/or protected by a protective cap that can be fixed to the head housing, with a through-opening for the reflected light.

15. Testing device according to claim 1, wherein in the evaluation housing are arranged:
an I/O board in order to provide the other circuit boards with the necessary electrical connections, to provide the plug socket however with the socket-specific connections, wherein the I/O circuit board is arranged in particular close to the plug socket to which it is electrically connected, and in particular is fastened to the rear end wall of the evaluation housing;
an interface circuit board that carries at least the evaluation circuit for the sensor signals; and
an interface circuit board electrically connected thereto, which comprises electrical inputs and outputs corresponding to the requirements of the light source and sensor as well as the I/O circuit board.

16. Kit for creating different variants of a testing device with a housing and multiple electrical assemblies to be accommodated therein, in particular electrical circuit boards, in particular a testing device according to claim 1,
the kit for the housing comprising the following kit parts:
at least one type of evaluation housing, in which the processing unit can be accommodated;
at least one type of head housing, in which the light source and the optical sensor can be accommodated; and
multiple types of elongated tube-shaped distance housings, through which or along which the electrical lines between the head housing and evaluation housing can be laid,
wherein the three housing parts are designed in such a way that they can be connected to one another in a detachable but tight manner.

17. Kit according to claim 16, wherein the various types of distance housing include both a straight type as well as an angled or bent type.

18. Kit according to claim 16, further comprising:
a flange plate for fastening to the rear-side end face or, as rear side, at least one type of evaluation housing;
and/or
an adapter plate for fastening to the flange plate;
and/or
at least one type of strain relief device for fastening to the evaluation housing or the flange plate or the adapter plate;
and/or
at least one types of plug socket for arranging a type of the evaluation housing in a wall;
and/or
multiple types of electrical signal lines differing as regards their length, in the form of electrically shielded coaxial cables, in which in particular each individual wire of the line is separately shielded as coaxial cable.

19. Kit according to claim 16, further comprising:
an I/O circuit board in order to provide the other circuit boards with the necessary electrical connections, specifically to provide the plug socket with the socket-specific connections that can be connected to the at least one plug socket;
and/or
an evaluation circuit board that carries at least the evaluation circuit for the sensor signals;
and/or
an interface circuit board electrically connected thereto, which has electrical inputs and outputs corresponding to the requirements of the light source and sensor as well as the I/O circuit board.
